(19) United States
(12) Patent Application Publication
(10) Pub. No.: US 2024/0300485 A1
(43) Pub. Date: Sep. 12, 2024

(54) LIGHTING-RESPONSIVE VEHICLE CONTROL

(71) Applicant: Ford Global Technologies, LLC, Dearborn, MI (US)

(72) Inventors: Brendan Francis Diamond, Grosse Pointe, MI (US); Andrew Denis Lewandowski, Sterling Heights, MI (US); Keith Weston, Canton, MI (US); Jordan Barrett, Milford, MI (US)

(73) Assignee: Ford Global Technologies, LLC, Dearborn, MI (US)

(21) Appl. No.: 18/178,590

(22) Filed: Mar. 6, 2023

(51) Int. Cl. B60W 30/095; B60W 10/04; B60W 10/18; B60W 10/20; B60W 30/12; B60W 30/16; B60W 30/18

(52) U.S. Cl. CPC B60W 30/0956; B60W 10/04; B60W 10/18; B60W 10/20; B60W 30/12; B60W 30/16; B60W 30/18163; B60W 2556/65; B60W 2710/18; B60W 2710/20; B60W 2720/10; B60W 2754/30

(57) ABSTRACT

In a host vehicle, it can be determined that current ambient light is below a light activation threshold. A target vehicle can be detected with lights insufficiently activated for the current ambient light. A component of the host vehicle can be actuated based on a location of the target vehicle detected with lights insufficiently activated.

### BACKGROUND

Vehicles can operate under various lighting conditions. In some cases, vehicle operations may be supported solely by ambient light. For example, during daylight, especially during sunny conditions, ambient light may be sufficient to support vehicle operations. In other examples, however, such as nighttime conditions, ambient light is typically insufficient to support vehicle operations.

### BRIEF DESCRIPTION OF THE DRAWINGS

FIG. 1 is a block diagram of an example vehicle system including for light-responsive vehicle control.

FIG. 2 is a diagram providing a top view of an example traffic scene.

FIG. 3 is a diagram providing a top view of another example traffic scene.

FIG. 4 is a process flow diagram illustrating an example process for lighting-responsive vehicle control.

### DESCRIPTION

### Introduction

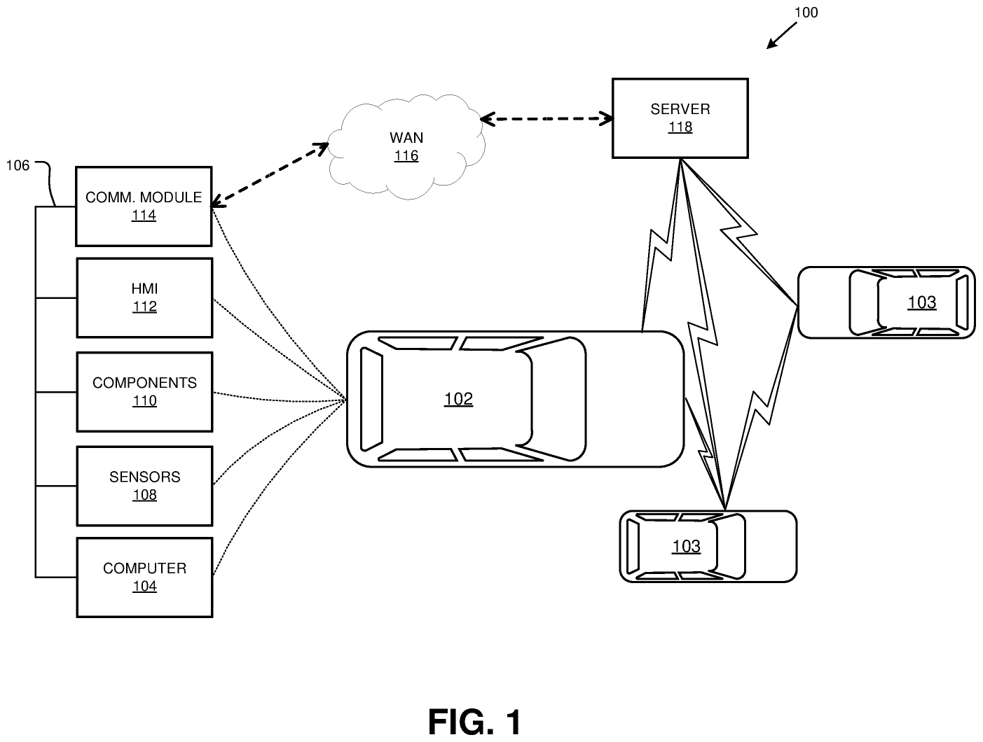

Referring to FIGS. 1-3, the present disclosure describes a system 100 in which lighting-responsive control can be provided in a host vehicle 102. Lighting-responsive control in the context of this disclosure means that the host vehicle is controlled responsive to ambient lighting conditions as well as a lighting state of at least one second or (or target) vehicle 103. Accordingly, as the host vehicle 102 operates on a roadway 202 with one or more target vehicles 103, the host vehicle 102 can detect both ambient light conditions as well as respective lighting states of target vehicles 103. When lighting conditions warrant a light output of a target vehicle 103 above a threshold, but the target vehicle 103 light output falls below this threshold, the host vehicle 102 can actuate one or more subsystems or components 110 to take an action, e.g., adjust a host vehicle 102 speed and/or distance from the target vehicle 103, based on the lighting state of the target vehicle 103.

As described herein, a system for a host vehicle comprises a computer that includes a processor and a memory, the memory storing instructions executable by the processor including instructions to determine that current ambient light is below a light activation threshold; detect a target vehicle with lights insufficiently activated for the current ambient light; and actuate a component of the host vehicle based on a location of the target vehicle detected with lights insufficiently activated. The instructions may further include instructions to predict a trajectory of the target vehicle, wherein activating the component based on the location further includes activating the component based on the predicted trajectory.

Actuating the component of the host vehicle based on the location of the target vehicle can include suppressing movement of the host vehicle until the target vehicle passes the host vehicle, changing a lane of travel of the host vehicle and/or maintaining the lane of travel of the host vehicle to attempt to avoid the target vehicle, adjusting a speed of the host vehicle to increase a distance between the host vehicle and the target vehicle, and/or adjusting a speed and/or distance setting of a driver assist system, and can be further based on input from a driver state monitoring system.

The component of the vehicle can be a propulsion, braking, or steering component, and/or a wireless transmitter.

The light activation threshold can be dependent on a distance of the target vehicle from the host vehicle, and can be calibrated for the host vehicle and/or the current ambient light.

A method in a host vehicle, comprises determining that current ambient light is below a light activation threshold; detecting a target vehicle with lights insufficiently activated for the current ambient light; and actuating a component of the host vehicle based on a location of the target vehicle detected with lights insufficiently activated. The method of can further comprise predicting a trajectory of the target vehicle, wherein activating the component based on the location further includes activating the component based on the predicted trajectory.

Actuating the component of the host vehicle based on the location of the target vehicle can include suppressing movement of the host vehicle until the target vehicle passes the host vehicle, changing a lane of travel of the host vehicle and/or maintaining the lane of travel of the host vehicle to attempt to avoid the target vehicle, adjusting a speed of the host vehicle to increase a distance between the host vehicle and the target vehicle, and/or adjusting a speed and/or distance setting of a driver assist system, and can be further based on input from a driver state monitoring system.

The component of the vehicle can be a propulsion, braking, or steering component, and/or a wireless transmitter.

The light activation threshold can be dependent on a distance of the target vehicle from the host vehicle, and can be calibrated for the host vehicle and/or the current ambient light.

### System Elements

As seen in FIG. 1, a system 100 includes a host vehicle 102 that in turn includes a computer 104 that is communicatively coupled via a communication network, such as a vehicle network 106, with various elements including sensors 108, subsystems or components 110 such as steering, propulsion, and braking, a human machine interface (HMI) 112, and a communication module 114.

The vehicle computer 104 (and also a remote server 118 discussed below) includes a processor and a memory. A memory of a computer 104 such as those described herein includes one or more forms of computer 104 readable media, and stores instructions executable by the vehicle computer 104 for performing various operations, such that the vehicle computer is configured to perform the various operations, including as disclosed herein.

For example, a vehicle computer 104 can be a generic computer 104 with a processor and memory as described above and/or may include an electronic control unit ECU or controller for a specific function or set of functions, and/or a dedicated electronic circuit including an ASIC (application specific integrated circuit) that is manufactured for a particular operation, e.g., an ASIC for processing sensor 108 data and/or communicating the sensor 108 data. In another example, a vehicle computer 104 may include an FPGA (Field-Programmable Gate Array) which is an integrated circuit manufactured to be configurable by a user. Typically, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected to the FPGA circuit. In some examples, a combination of processor(s), ASIC(s), and/or FPGA circuits may be included in a computer 104. Further, the vehicle computer 104 could include a plurality of computers 104 in the vehicle, e.g., a plurality of ECUs (electronic control units) or the like, operating together to perform operations ascribed herein to the vehicle computer 104.

The memory can be of any type, e.g., hard disk drives, solid state drives, servers 118, or any volatile or non-volatile media. The memory can store the collected data sent from the sensors 108. The memory can be a separate device from the computer 104, and the computer 104 can retrieve information stored by the memory via a communication network in the vehicle such as the vehicle network 106, e.g., over a CAN bus, a wireless network, etc. Alternatively or additionally, the memory can be part of the computer 104, e.g., as a memory of the computer 104.

The computer 104 may include programming to operate one or more components 110 such as vehicle brakes, propulsion (e.g., one or more of an internal combustion engine, electric motor, hybrid engine, etc.), steering, climate control, interior and/or exterior lights, etc., as well as to determine whether and when the computer 104, as opposed to a human operator, is to control such operations. Additionally, the computer 104 may be programmed to determine whether and when a human operator is to control such operations. The computer 104 may include or be communicatively coupled to, e.g., via a vehicle network 106 such as a communications bus as described further below, more than one processor, e.g., included in components 110 such as sensors 108, electronic control units (ECUs) or the like included in the vehicle for monitoring and/or controlling various vehicle components, e.g., a powertrain controller, a brake controller, a steering controller, etc.

The computer 104 is generally arranged for communications on a vehicle network 106 that can include a communications bus in the vehicle such as a controller area network CAN or the like, and/or other wired and/or wireless mechanisms. The vehicle network 106 is a communications network via which messages can be exchanged between various devices, e.g., sensors 108, components 110, computer 104(s), etc. in vehicle. The computer 104 can be generally programmed to send and/or receive, via vehicle network 106, messages to and/or from other devices in vehicle e.g., any or all of ECUs, sensors 108, actuators, components 110, communications module, a human machine interface (HMI) 112, etc. For example, various component 110 subsystems (e.g., components 110 can be controlled by respective ECUs) and/or sensors 108 may provide data to the computer 104 via the vehicle network 106.

Further, in cases in which computer 104 actually comprises a plurality of devices, the vehicle network 106 may be used for communications between devices represented as computer 104 in this disclosure. For example, vehicle network 106 can include a controller area network (CAN) in which messages are conveyed via a CAN bus, or a local interconnect network (LIN) in which messages are conveyed via a LIN bus. In some implementations, vehicle network 106 can include a network in which messages are conveyed using other wired communication technologies and/or wireless communication technologies e.g., Ethernet, WiFi®, Bluetooth®, etc. Additional examples of protocols that may be used for communications over vehicle network 106 in some implementations include, without limitation, Media Oriented System Transport (MOST), Time-Triggered Protocol (TTP), and FlexRay. In some implementations, vehicle network 106 can represent a combination of multiple networks, possibly of different types, that support communications among devices in vehicle. For example, vehicle network 106 can include a CAN (or CAN bus) in which some devices in vehicle communicate via a CAN bus, and a wired or wireless local area network in which some device in vehicle communicate according to Ethernet or Wi-Fi communication protocols.

The vehicle 102 typically includes a variety of sensors 108. A sensor 108 is a device that can obtain one or more measurements of one or more physical phenomena. Some sensors 108 detect internal states of the vehicle, for example, wheel speed, wheel orientation, and engine and transmission variables. Some sensors 108 detect the position or orientation of the vehicle, for example, global positioning system GPS sensors 108; accelerometers such as piezo-electric or microelectromechanical systems MEMS; gyroscopes such as rate, ring laser, or fiber-optic gyroscopes; inertial measurements units IMU; and magnetometers. Some sensors 108 detect the external world, for example, radar sensors 108, scanning laser range finders, light detection and ranging LIDAR devices, and image processing sensors 108 such as cameras. A LIDAR device detects distances to objects by emitting laser pulses and measuring the time of flight for the pulse to travel to the object and back. Some sensors 108 are communications devices, for example, vehicle-to-infrastructure V2I or vehicle-to-vehicle V2V devices. Sensor 108 operation can be affected by obstructions, e.g., dust, snow, insects, etc. Often, but not necessarily, a sensor 108 includes a digital-to-analog converter to converted sensed analog data to a digital signal that can be provided to a digital computer 104, e.g., via a network.

Sensors 108 can include a variety of devices, and can be disposed to sense and environment, provide data about a machine, etc., in a variety of ways. For example, a sensor 108 could be mounted to a stationary infrastructure element on, over, or near a road. Moreover, various controllers in a vehicle may operate as sensors 108 to provide data via the vehicle network 106 or bus, e.g., data relating to vehicle speed, acceleration, location, subsystem and/or component 110 status, etc. Further, other sensors 108, in or on a vehicle, stationary infrastructure element, etc., infrastructure could include cameras, short range radar, long range radar, LIDAR, and/or ultrasonic transducers, weight sensors 108, accelerometers, motion detectors, etc., i.e., sensors 108 to provide a variety of data. To provide just a few non-limiting examples, sensor 108 data could include data for determining a position of a component 110, a location of an object, a speed of an object, a type of an object, a slope of a roadway 202, a temperature, a presence or amount of moisture, a fuel level, a data rate, etc.

The computer 104 may include programming to command one or more actuators to operate one or more vehicle subsystems or components 110, such as vehicle brakes, propulsion, or steering. That is, the computer 104 may actuate control of acceleration in the vehicle by controlling one or more of an internal combustion engine, electric motor, hybrid engine, etc., and/or may actuate control of brakes, steering, climate control, interior and/or exterior lights, etc. The computer 104 may include or be communicatively coupled to, e.g., via a vehicle network 106, more than one processor, e.g., included in components 110 such as sensors 108, electronic control units (ECUs) or the like for monitoring and/or controlling various vehicle components, e.g., ECUs or the like such as a powertrain controller, a brake controller, a steering controller, etc.

The vehicle can include an HMI 112 (human-machine interface), e.g., one or more of a display, a touchscreen display, a microphone, a speaker, etc. The user can provide input to devices such as the computer 104 via the HMI 112. The HMI 112 can communicate with the computer 104 via the vehicle network 106, e.g., the HMI 112 can send a message including the user input provided via a touchscreen, microphone, a camera that captures a gesture, etc., to a computer 104, and/or can display output, e.g., via a screen, speaker, etc. Further, operations of the HMI 112 could be performed by a portable user device (not shown) such as a smart phone or the like in communication with the vehicle computer 104, e.g., via Bluetooth or the like.

The computer 104 may be configured for communicating via a vehicle to vehicle communication module 114 or interface with devices outside of the vehicle, e.g., through a wide area network 116 and/or vehicle to vehicle V2V, vehicle-to-infrastructure or everything V2X or vehicle-to-everything including cellular communications C-V2X wireless communications cellular, DSRC, etc. to another vehicle, to an infrastructure element typically via direct radio frequency communications and/or typically via the network a remote server 118. The module could include one or more mechanisms by which the computers 104 of vehicles may communicate, including any desired combination of wireless e.g., cellular, wireless, satellite, microwave and radio frequency communication mechanisms and any desired network topology or topologies when a plurality of communication mechanisms are utilized. Exemplary communications provided via the module can include cellular, Bluetooth, IEEE 802.11, dedicated short range communications DSRC, cellular V2X CV2X, and the like.

A computer 104 can be programmed to communicate with one or more remote sites such as a remote server 118, via a wide area network 116. The wide area network 116 can include one or more mechanisms by which a vehicle computer 104 may communicate with, for example, a remote server 118. For example, a vehicle 102 could include a wireless transceiver (i.e., transmitter and/or receiver) to send and receive messages outside of the vehicle 102. Accordingly, the network can include one or more of various wired or wireless communication mechanisms, including any desired combination of wired e.g., cable and fiber and/or wireless e.g., cellular, wireless, satellite, microwave, and radio frequency communication mechanisms and any desired network topology or topologies when multiple communication mechanisms are utilized. Exemplary communication networks include wireless communication networks e.g., using Bluetooth, Bluetooth Low Energy BLE, IEEE 802.11, vehicle-to-vehicle V2V or vehicle to everything V2X such as cellular V2X CV2X, Dedicated Short Range Communications DSRC, etc., local area networks and/or wide area networks 116, including the Internet, providing data communication services.

The server 118 may include one or more computing devices, e.g., having respective processors and memories and/or associated data stores, that are accessible via the wide area network 116.

### Exemplary System Operations

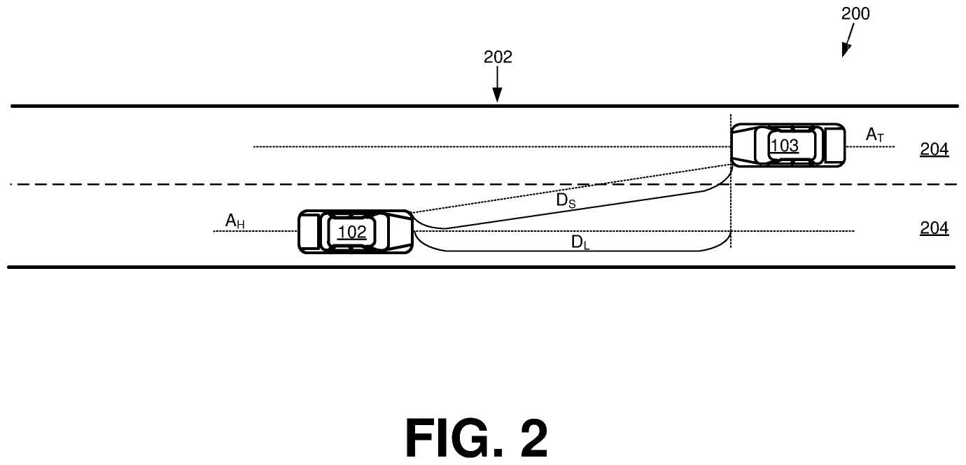

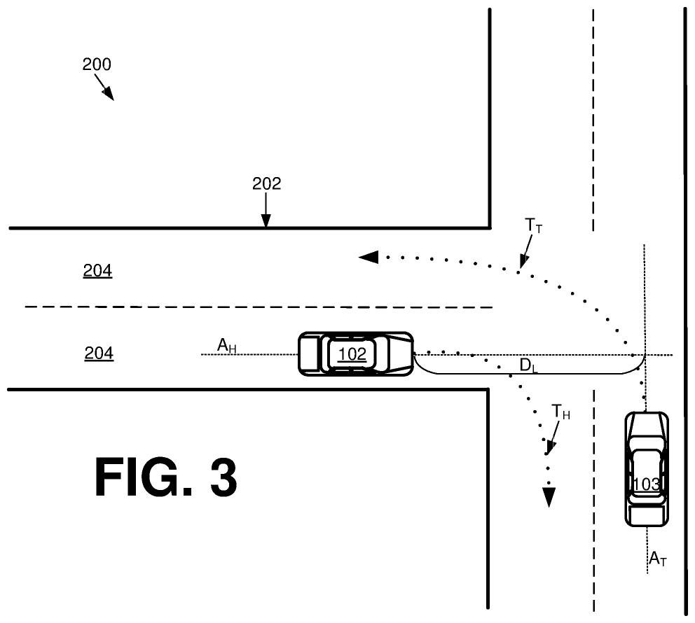

FIGS. 2 and 3 show a host and target vehicles 102, 103 operating in respective traffic scenes 200 that include respective roadways 202. With data from sensors 108, e.g., camera sensors 108, a host vehicle computer 104 can determine an amount of ambient light and/or an amount of light, typically a brightness in lumens, emitted by a vehicle 103. For example, exterior camera sensors 108 could obtain an image or images of a target vehicle 103, and a distance sensor 108 such as a radar or lidar could provide a distance d to a target vehicle 103 lamp or lamps. Then a luminosity L could be calculated based on an apparent brightness b determined from the camera 108 image(s) according to the inverse square law:

$$b = \frac{L}{4 π {d}^{2}}$$

Further, while the vehicle 102 is operating, a vehicle computer 104 can detect a level or amount of ambient light based on data from one or more vehicle sensors 108. For example, in ambient light level may be specified as a brightness measured in lumens. Some existing vehicles include mechanisms for ambient light determination; any suitable technique for measuring an ambient light level, e.g., based on optical camera data, could be used in the context of the present disclosure. As used herein, “ambient light” means visible light in an environment around a vehicle 102 from a source or sources other than the vehicle 102. For example, the sun, the moon, streetlights, building lights, lights from other vehicles 103, etc., could be a source or sources of ambient light.

Upon determining an ambient light level, the computer 104 can compare the current ambient light level to a vehicle light activation threshold. The vehicle light activation threshold is a specified amount or level of ambient light at which exterior lights, e.g., headlights and taillights, of vehicles 102, 103 should be activated. Accordingly, if the current ambient light level is below the light activation threshold, then the computer 104 may proceed to determine levels of light respectively emitted by one or more target vehicles 103. The computer 104 can then pair a light level committed by a target vehicle 103 to a second light threshold, which may be referred to as the vehicle light emission threshold, to detect a target vehicle 103 with lights insufficiently activated for the current ambient light. That is, a target vehicle 103 emitting light below the vehicle light emission threshold is deemed to be operating with lights insufficiently activated for the current ambient light.

Upon identifying a target vehicle 103 with insufficiently activated lights, the computer 104 can actuate a component 110 of the host vehicle 102 based on a location of the target vehicle 103 detected with lights insufficiently activated. For example, as described further below, the computer 104 could perform actuation of a component 110 based on a location of the vehicle 102 on a map, and/or based on a relative location of the target vehicle 103 with respect to the host vehicle 102. As described further below, the component 110 can be any of for example, a propulsion, breaking, steering, and/or a communication subsystem 110.

A location of an object including a vehicle 102, 103 can be determined in a variety of ways. For example, a vehicle computer 104 can obtain localization data and can perform simultaneous localization and mapping (SLAM) to determine a location of the vehicle 102 with respect to objects around the vehicle 102 such as road lane markings, traffic signs, other vehicles 103, etc. References herein to a “location” of a vehicle 102 (or some other object) mean a place or position on a surface of the earth occupied by the object. A location can be specified according to a global coordinate system, e.g., geo-coordinates used by a Global Navigation Satellite System (GNSS), for example, sometimes referred to as Global Positioning System (GPS) coordinates. Further, a location of an object such as another vehicle 103 could be specified with respect to a coordinate system relative to the host vehicle 102, e.g., a polar or Cartesian coordinate system with a point on the vehicle 102 as an origin. A location could alternatively or additionally be specified relative to some other object, e.g., as a distance and/or heading with respect to the other object.

Location data is included in localization data, which in the context of this document means (a) data that measures or indicates a position, location, and/or pose of a vehicle 102 or some other object according to some coordinate system and/or relative to some other object such as a vehicle 103, and (b) data about a physical state of a vehicle 102 or some other object such as another vehicle 103. For example, localization data could include a vehicle 102 location, i.e., e.g., specifying geo-coordinates or the like for a current vehicle 102 location and/or coordinates for the vehicle 102, and/or respective coordinates for other objects, such as other vehicle 103, according to a local coordinate system (e.g., polar or Cartesian) for the vehicle 102. Localization data could also include a distance and/or relative heading (i.e., direction) of a vehicle 102 from some object, such as another vehicle 103, an intersection, a building, etc. The “physical state” of an object such as a vehicle 102, 103 means a measurement or setting of the object describing or governing object movement. For example, a physical state of an object could include its speed, acceleration, turn (or yaw) rate and/or heading, without limitation. A physical state of the vehicle 150 could further include settings such as a transmission setting (park, drive, reverse, etc.), a steering wheel angle, a state of engagement, e.g., brakes engaged or not engaged, etc.

Further, as illustrated in FIG. 2, a computer 104 and a host vehicle 102 can detect a target vehicle 103 and can use data from one or more sensors 108 according to any suitable localization technique to determine distances between the vehicles 102, 103, such as determine a shortest distance D_{S} and/or a longitudinal distance D_{L} between the host vehicle 102 and the target vehicle 103. The shortest distance D_{S} is a distance between closest points on the respective vehicles 102, 103. The longitudinal distance is a distance along a longitudinal axis A_{H} of the vehicle 102 from a forward point on the vehicle 102 to a point of intersection with a line perpendicular to the axis, and intersecting a longitudinal axis A_{T} of the vehicle 103 at a point on the vehicle 103. Further, as seen in FIG. 3, the distance D_{L} could be determined as a distance from the vehicle 102 along the longitudinal axis A_{H} to a longitudinal axis A_{T} of the vehicle 103.

In various examples discussed below, a vehicle computer 104 may compare distances of the host vehicle 102 from a target vehicle 103, such as the illustrated distances D_{S}, D_{L}, to a threshold distance to determine an action such as weather and/or how to actuate a host vehicle component 110. Threshold distances and light thresholds such as the vehicle light activation threshold and the vehicle light emission threshold mentioned above, could be determined by empirical testing and/or simulation. For example, visibility of a target vehicle 103 could be evaluated at various distances and at various levels of ambient light and/or target vehicle 103 light emissions. In other words, the light activation threshold could be calibrated for the host vehicle and/or current ambient light. Alternatively or additionally, in some instances, thresholds such as the light activation threshold or vehicle light emission threshold could be specified by law or regulation. Yet further alternatively or additionally, thresholds could be calibrated for environmental conditions, e.g., a vehicle light activation threshold could be lower, and a vehicle light emission threshold could be higher, based host vehicle sensors 108 on detecting an environmental condition likely to lower visibility, such as fog, haze, rain, or other precipitation.

In one example, a vehicle computer 104 can be programmed to predict a trajectory T_{T} (see FIG. 3) of a target vehicle 103, wherein activating the component based on the location further includes activating the component based on the predicted trajectory T_{T}. A predicted trajectory T_{T} can be determined for a vehicle 103 based on data from sensors 108 included in a host vehicle 102. A trajectory for an object such as a vehicle 103 can be determined as part of a SLAM algorithm, for example, e.g., based on determining a plurality of real-world locations for the object and determining a predicted trajectory T_{T} that includes predicted locations, speeds and directions for the object. The vehicle computer 104 can then compare a location and/or predicted or planned path or trajectory T_{H}, e.g., as may be determined according to a path planning or prediction algorithm, of the host vehicle 102 to the predicted trajectory T_{T} of the other vehicle 103.

Typically, a trajectory specifies a set of points through or over which an object will pass, along with an object velocity vector (i.e., heading and speed) specified for each point. Further, respective times at which the object will pass over or through the points can be determined. Comparing trajectories can include determining predicted distances of the trajectories from one another at one or more times. For example, a vehicle computer 104 can compare a host vehicle 102 planned or predicted trajectory TH with a target vehicle 103 planned or predicted trajectory T_{T} to determine if, at any time within a specified time horizon, e.g., 30 seconds, 60 seconds, etc., the vehicles 102, 103 are predicted to be within a threshold distance of each other. The threshold distance can be determined based on empirical testing and/or simulation as a minimum distance at which the vehicles 102, 103 may come within each other providing an appropriate or sufficient minimum margin or distance, possibly accounting for the fact that a vehicle 103 may be emitting light below a current vehicle light emission threshold, and further possible accounting for environmental conditions (e.g., precipitation, fog, etc.), vehicle 102, 103 relations to each other (e.g., angle of travel, i.e., heading angles of trajectories with respect to each other, relative speeds, etc.), and/or road conditions (e.g., road surface, curves or turns, etc.). The empirical testing can thus take into account, in addition to various ambient light conditions, various environmental and road conditions, and/or vehicle 102, 103 locations, orientations, and/or speeds, etc. Thus, although the present disclosure could be implemented with one threshold distance, implementations are also contemplated in which a computer 104 stores a plurality of threshold distances, where each of the plurality of threshold distances is associated with, i.e., can be used in the case of, specific environmental conditions, road conditions, vehicle 102, 103 orientations (e.g., relative heading angles), etc.

In some implementations, actuating the component of the host vehicle based on the location of the target vehicle includes suppressing movement of the host vehicle until the target vehicle passes the host vehicle. For example, upon determining that a distance between the host and target vehicles 102, 103 is below a minimum distance, and/or that respective vehicle trajectories T_{H}, T_{T} are or will be below a minimum distance, a computer 104 in the host vehicle 102 that actuate a brake component 110 and/or could suppress actuation of a propulsion component 110 to maintain a host vehicle 102 at a current location until the target vehicle 103 moves to beyond the minimum distance of the target vehicle 102.

In some implementations, actuating the component of the host vehicle 102 based on the location of the target vehicle 103 includes changing a lane of travel of the host vehicle 102 and/or maintaining the lane of travel of the host vehicle 102 to attempt to avoid the target vehicle 103. For example, the vehicle computer 104 could determine that a minimum distance between the host and target vehicles 102, 103 can be maintained by changing lanes, and can then actuate vehicle steering and/or propulsion components 110 to change lanes. Alternatively or additionally, the host vehicle computer 104 could determine to adjust a speed of the host vehicle 102 to maintain or increase a distance between the host and target vehicles 102, 103.

Yet further alternatively or additionally, actuating a host vehicle component 110 based on a location of a target vehicle 103 could include adjusting a speed and/or distance setting of a driver assist system. A driver assistance system means a vehicle component or set of vehicle components 110 comprising a vehicle 102 subsystem by which a computer 104 can control one or more of vehicle steering, propulsion, and braking. Such systems may be referred to as Advanced Driver Assistance Systems (ADAS). ADAS can include systems such as adaptive cruise control, which can control speed of a vehicle in certain situations, including by adapting the speed of a host vehicle 102 to one or more other vehicles 103; lane-centering, in which vehicle 102 steering is controlled to maintain a lateral position of a vehicle 102 in the lane of travel; and lane-changing, in which a vehicle steering, acceleration, and/or braking can be controlled to move a vehicle 102 from one lane of travel to another. These ADAS can have speed and/or distance settings or parameters. For example, an adaptive cruise control can have a “set speed” that is a target speed for a vehicle 102 to travel, wherein the vehicle 102 speed is typically further controlled based on a minimum following distance from a lead vehicle 103. Similarly, lane-keeping or centering and/or lane-changing ADAS can specify distances from other vehicles, distances from lane lines, maximum and/or minimum speeds relative to other vehicles, etc. These speed and/or distance parameters could be adjusted by a vehicle 104 based on stored adjustments to be made for a target vehicle 103 with insufficient light emissions. Such stored adjustments could be determined based on empirical testing, for example, e.g., operating a test vehicles 102, 103 in an environment and recording speeds and/or distances for various environmental conditions, road conditions, etc.

In some implementations, actuating the component 110 of the vehicle 102 could include actuating a transmitter component 110, e.g., to transmit a V2X message or the like to alert other vehicles 103, and/or to provide information to a server 118, about a vehicle 103, including its location and/or predicted trajectory, traveling with insufficient light emissions.

In some implementations, actuating the component 110 of the vehicle 102 could be based on part from input from a driver state monitoring (DSM) system. For example, any suitable driver state monitoring (DSM) system could be utilized to determine data about an operator such as an operator gaze direction, and orientation, position, and/or pose of an operator head, a position of other operator body parts, such as arms or hands, etc., based on image data from one or more cameras 108. For example, it will be understood that a computer 104 could detect a gaze direction of the operator in the image data, e.g., by using any suitable facial-detection technique, e.g., knowledge-based techniques such as a multiresolution rule-based method; feature-invariant techniques such as grouping of edges, space gray-level dependence matrix, or mixture of Gaussian; template-matching techniques such as shape template or active shape model; or appearance-based techniques such as eigenface decomposition and clustering, Gaussian distribution and multilayer perceptron, neural network, support vector machine with polynomial kernel, a naive Bayes classifier with joint statistics of local appearance and position, higher order statistics with hidden Markov model, or Kullback relative information. Then the computer 104 can use outputs produced as a byproduct of the facial detection that indicate the gaze direction of the eyes.

In some implementations, if a DSM determines that a vehicle 102 operator is looking toward a target vehicle 103, then distance and/or speed adjustments discussed above could be modified, e.g., a vehicle propulsion component 110 could be actuated to allow the vehicle 102 to be within a closer distance of a target vehicle 103 then would be permitted absent a determination by the DSM that the vehicle 102 operator is aware of the target vehicle 103 with insufficient lighting.

### Example Processes

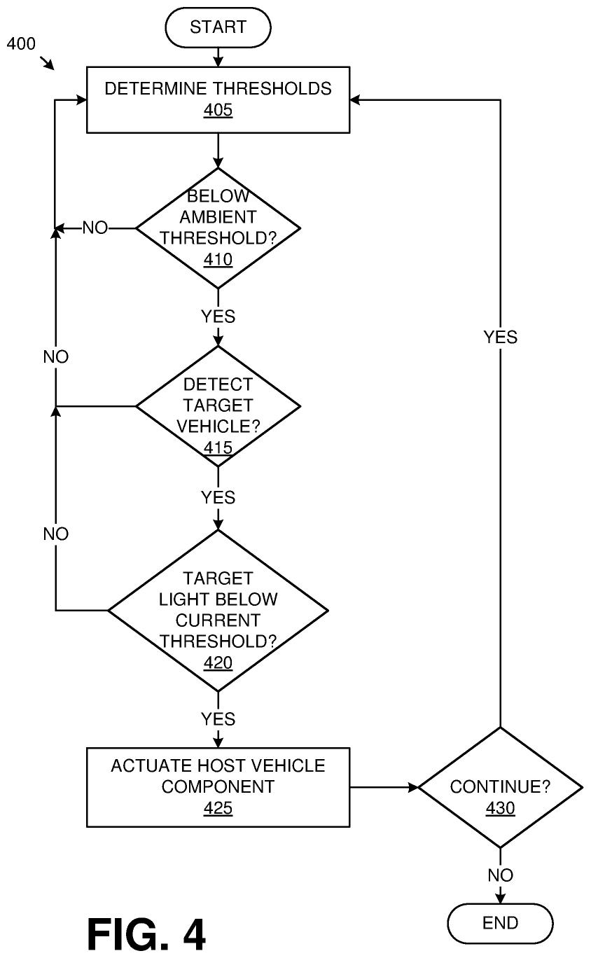

FIG. 4 is a process flow diagram of an example process 400 for controlling a host vehicle 102 based on a detected amount of light emitted from a target vehicle 103. The process 400 can be carried out according to instructions in a host vehicle computer 104, for example.

The process 400 can begin while the vehicle 102 is operating on a roadway 202, in which the computer 104 can determine the vehicle light activation threshold, the vehicle light emission threshold, and/or distance thresholds described above. For example, as explained above, thresholds could be stored in a memory of the computer 104, and could be calibrated for a type of vehicle 102 and/or operating conditions, such as a speed of the vehicle 102, a relative speed of the vehicle 102 with respect to a vehicle 103, road conditions, environmental conditions such as precipitation or fog, etc.

Next, in a block 410, the computer 104 can determine whether currently detected ambient light is below the vehicle light activation threshold. If not, the process 400 can return to the block 405. Otherwise, a block 415 can be executed next.

In the block 415, the computer 104 determines whether a target vehicle 103 is detected. Typically, the computer 104 will determine whether one or more target vehicles 103 are detected within a specified or threshold distance of the host vehicle 102. This threshold distance can be determined as a distance within which the host vehicle 102 may need to consider a trajectory of the target vehicle 103 with respect to its own trajectory, and/or may be determined based on a current host vehicle speed and/or environmental conditions, e.g., current ambient light levels, presence or absence of precipitation or fog, etc. If no target vehicles 103 are detected, then the process 400 can return to the block 405. Otherwise, a block 420 can be executed next.

In the block 420, the computer 104 determines whether a brightness of light emitted by a detected target vehicle 103 is below the vehicle light emission threshold. If not, the process 400 can return to the block 405. Otherwise, a block 425 can be executed next.

In the block 425, the vehicle computer 104 can actuate one or more host vehicle components 110, and the process 400 can then proceed to a block 430.

In the block 430, the computer 104 can determine whether to continue the process 400. For example, the process 400 in some examples could be deactivated by user input. Further, the process 400 ends when a vehicle 102 is powered off. If the process 400 is to continue, then the process 400 can return to the block 405. Otherwise, the process 400 can end following the block 430.

### CONCLUSION

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

In the drawings, the same reference numbers indicate the same elements. Further, some or all of these elements could be changed. With regard to the media, processes, systems, methods, etc. described herein, it should be understood that, although the steps of such processes, etc. have been described as occurring according to a certain ordered sequence, unless indicated otherwise or clear from context, such processes could be practiced with the described steps performed in an order other than the order described herein. Likewise, it further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

The adjectives first and second are used throughout this document as identifiers and, unless explicitly stated otherwise, are not intended to signify importance, order, or quantity.

The term exemplary is used herein in the sense of signifying an example, e.g., a reference to an exemplary widget should be read as simply referring to an example of a widget.

Use of in response to, based on, and upon determining herein indicates a causal relationship, not merely a temporal relationship.

Computer executable instructions may be compiled or interpreted from computer programs created using a variety of programming languages and/or technologies, including, without limitation, and either alone or in combination, Java, C, C, Visual Basic, Java Script, Perl, HTML, etc. In general, a processor e.g., a microprocessor receives instructions, e.g., from a memory, a computer readable medium, etc., and executes these instructions, thereby performing one or more processes, including one or more of the processes described herein. Such instructions and other data may be stored and transmitted using a variety of computer readable media. A file in a networked device is generally a collection of data stored on a computer readable medium, such as a storage medium, a random access memory, etc. A computer readable medium includes any medium that participates in providing data e.g., instructions, which may be read by a computer. Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

1. A system for a host vehicle, comprising computer that includes a processor and a memory, the memory storing instructions executable by the processor including instructions to:
determine that current ambient light is below a light activation threshold;
detect a target vehicle with lights insufficiently activated for the current ambient light; and
actuate a component of the host vehicle based on a location of the target vehicle detected with lights insufficiently activated.

2. The system of claim 1, the instructions further including instructions to predict a trajectory of the target vehicle, wherein activating the component based on the location further includes activating the component based on the predicted trajectory.

3. The system of claim 1, wherein actuating the component of the host vehicle based on the location of the target vehicle includes suppressing movement of the host vehicle until the target vehicle passes the host vehicle.

4. The system of claim 1, wherein actuating the component of the host vehicle based on the location of the target vehicle includes changing a lane of travel of the host vehicle and/or maintaining the lane of travel of the host vehicle to attempt to avoid the target vehicle.

5. The system of claim 1, wherein actuating the component of the host vehicle based on the location of the target vehicle includes adjusting a speed of the host vehicle to increase a distance between the host vehicle and the target vehicle.

6. The system of claim 1, wherein actuating the component of the host vehicle based on the location of the target vehicle includes adjusting a speed and/or distance setting of a driver assist system.

7. The system of claim 1, wherein the component of the vehicle is a propulsion, braking, or steering component.

8. The system of claim 1, wherein the component of the vehicle is a wireless transmitter.

9. The system of claim 1, wherein the light activation threshold is dependent on a distance of the target vehicle from the host vehicle.

10. The system of claim 1, wherein the light activation threshold is calibrated for the host vehicle.

11. The system of claim 1, wherein the light activation threshold is calibrated for the current ambient light.

12. The system of claim 1, wherein actuating the component of the host vehicle is further based on input from a driver state monitoring system.

13. A method in a host vehicle, comprising:
determining that current ambient light is below a light activation threshold;
detecting a target vehicle with lights insufficiently activated for the current ambient light; and
actuating a component of the host vehicle based on a location of the target vehicle detected with lights insufficiently activated.

14. The method of claim 13, further comprising predicting a trajectory of the target vehicle, wherein activating the component based on the location further includes activating the component based on the predicted trajectory.

15. The method of claim 13, wherein actuating the component of the host vehicle based on the location of the target vehicle includes (a) suppressing movement of the host vehicle until the target vehicle passes the host vehicle, (b) changing a lane of travel of the host vehicle and/or maintaining the lane of travel of the host vehicle to attempt to avoid the target vehicle, or (c) adjusting a speed of the host vehicle to increase a distance between the host vehicle and the target vehicle.

16. The method of claim 13, wherein actuating the component of the host vehicle based on the location of the target vehicle includes adjusting a speed and/or distance setting of a driver assist system.

17. The method of claim 13, wherein the component of the vehicle is a propulsion, braking, or steering component, or a wireless transmitter.

18. The method of claim 13, wherein the light activation threshold is dependent on a distance of the target vehicle from the host vehicle.

19. The method of claim 13, wherein the light activation threshold is calibrated for the host vehicle and/or for the current ambient light.

20. The method of claim 13, wherein actuating the component of the host vehicle is further based on input from a driver state monitoring system.
